(19) United States
(12) Patent Application Publication
(10) Pub. No.: US 2025/0133592 A1
(43) Pub. Date: Apr. 24, 2025

(54) Management Prioritization for Subsequent Small Data Transmission in Inactive Mode

(71) Applicant: Apple Inc., Cupertino, CA (US)

(72) Inventors: Jie Cui, San Jose, CA (US); Yang Tang, San Jose, CA (US); Qiming Li, Beijing (CN); Manasa Raghavan, Sunnyvale, CA (US); Xiang Chen, Campbell, CA (US); Dawei Zhang, Saratoga, CA (US); Hong He, Cupertino, CA (US); Yuanye Wang, San Jose, CA (US); Haitong Sun, Cupertino, CA (US); Chunhai Yao, Beijing (CN)

(21) Appl. No.: 18/835,546

(22) PCT Filed: Feb. 11, 2022
(86) PCT No.: PCT/CN2022/076019

§ 371 Date: Aug. 2, 2024

(51) Int. Cl. H04W 74/0816; H04W 74/08; H04W 76/20

(52) U.S. Cl. CPC H04W 74/0816; H04W 74/0875; H04W 76/20

(57) ABSTRACT

Methods, apparatuses, and systems are disclosed for determining prioritization of subsequent small data transmissions (SDTs) and measurement occasions for a UE in inactive mode. The UE may determine that one or more subsequent SDT occasions of an SDT session conflict in time with one or more measurement occasions scheduled during the SDT session. In response, the UE may determine which of the subsequent SDT occasions to utilize or forgo, and which of the measurement occasions to utilize or forgo. The procedure for making such determinations may vary based on the type of measurement occasion involved in the conflict. For example, the procedure may vary based on whether the measurement event pertains to inter-frequency neighbor cell measurement occasions, inter-RAT neighbor cell measurement occasions, intra-frequency neighbor cell measurement occasions, serving cell downlink measurement occasions, and/or serving cell paging occasions.

### FIELD

The present application relates to wireless communications, and more particularly to systems, apparatuses, and methods for resolving conflicts between small data transmission (SDT) sessions and cell measurement in cellular communications.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, virtual reality, augmented reality, cloud gaming, and navigation using the global positioning system (GPS), and are capable of operating sophisticated applications that utilize these and other functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1xRTT, 1xEV-DO, HRPD, eHRPD), IEEE 802.11 (WLAN or Wi-Fi), BLUETOOTH™ (BT), etc.

The ever-increasing number of features and functionality introduced in wireless communication devices also creates a continuous need for improvement in both wireless communications and in wireless communication devices. In particular, as UE devices improve to support additional functions, such as small data transmission (SDT) in inactive mode, UEs and networks may experience increased signaling conflicts. Accordingly, improvements in the field are desired.

### SUMMARY

Embodiments are presented herein of methods, apparatuses, and systems for resolving conflicts between small data transmission (SDT) sessions and cell measurement for a user equipment (UE) in inactive mode.

For example, a UE may determine that one or more subsequent SDT occasions of a plurality of periodic subsequent SDT occasions of an SDT session conflict in time with one or more measurement occasions of a plurality of measurement occasions scheduled during the SDT session. In response to the determining, the UE may forgo SDT transmission during at least a subset of the one or more subsequent SDT occasions that conflict in time with the one or more measurement occasions.

In some scenarios, the UE may perform a measurement procedure on at least a subset of the measurement occasions during which the UE forgoes SDT transmission.

In some scenarios, forgoing SDT transmission during at least the subset of the one or more subsequent SDT occasions may include delaying SDT transmission until a later SDT occasion that does not conflict in time with a measurement occasion. In some such scenarios, the UE may perform a timing alignment (TA) validation procedure after delaying the SDT transmission, but before the later SDT occasion.

In some scenarios, in response to determining that all of the subsequent SDT occasions of the SDT session conflict in time with measurement occasions of the plurality of measurement occasions scheduled during the SDT session, the UE may forgo SDT transmission on a fraction of the subsequent SDT occasions specified by a scaling factor. In some such scenarios, the UE may receive from a base station an indication of a value of the scaling factor. In some such scenarios, determining that all of the subsequent SDT occasions of the SDT session conflict in time with measurement occasions of the plurality of measurement occasions scheduled during the SDT session may include determining that the plurality of periodic subsequent SDT occasions has a periodicity that is the same as a periodicity of at least a subset of the plurality of measurement occasions that is included in a set of periodic measurement occasions.

In some scenarios, in response to determining that all of the subsequent SDT occasions of the SDT session conflict in time with measurement occasions of the plurality of measurement occasions scheduled during the SDT session, the UE may forgo SDT transmission until N measurement occasions have occurred, wherein N represents a number of carriers that the UE is scheduled to measure in connection with an inter-frequency neighbor cell measurement.

In some scenarios, in response to determining that all of the subsequent SDT occasions of the SDT session conflict in time with measurement occasions of the plurality of measurement occasions scheduled during the SDT session, the UE may forgo SDT transmission during each of the one or more subsequent SDT occasions of the SDT session. In some such scenarios, in response to determining that all of the subsequent SDT occasions of the SDT session conflict in time with measurement occasions of the plurality of measurement occasions scheduled during the SDT session, the UE may provide to a base station an indication that an SDT occasion configuration error has occurred.

In some scenarios, in response to determining that all of the subsequent SDT occasions of the SDT session conflict in time with paging occasions of the plurality of measurement occasions scheduled during the SDT session, the UE may scale a cycle length of the paging occasions. In some such scenarios, the UE may receive receiving from a base station an indication of a factor by which the cycle length of the paging occasions is to be increased.

In some scenarios, in response to determining that less than all of the subsequent SDT occasions of the SDT session conflict in time with measurement occasions of the plurality of measurement occasions scheduled during the SDT session, the UE may perform a subsequent SDT transmission during a subsequent SDT occasion of the SDT session that does not conflict in time with a measurement occasion of the plurality of measurement occasions.

In some scenarios, the UE may determine that a measurement object scheduled for measurement during a particular measurement occasion of the plurality of measurement occasions scheduled during the SDT session is a higher-priority measurement object. In response, the UE may forgo SDT transmission during the particular measurement occasion.

In some scenarios, the plurality of measurement occasions scheduled during the SDT session may include measurement occasions from one or more sets of periodic measurement occasions. In some such scenarios, the one or more sets of periodic measurement occasions include one or more of: a set of periodic inter-frequency neighbor cell measurement occasions; a set of periodic inter-RAT neighbor cell measurement occasions; a set of periodic intra-frequency neighbor cell measurement occasions; a set of periodic serving cell downlink measurement occasions; or a set of periodic serving cell paging occasions.

In some scenarios, the UE may forgo SDT transmission during each subsequent SDT occasion that conflicts in time with the one or more measurement occasions. The UE may also perform SDT transmission during each subsequent SDT occasion that does not conflict in time with the one or more measurement occasions.

A method is disclosed in which a UE may determine that one or more subsequent SDT occasions of a plurality of periodic subsequent SDT occasions of a SDT session conflict in time with one or more measurement occasions of a plurality of measurement occasions scheduled during the SDT session. In response to the determining, the UE may perform subsequent SDT transmission during at least a subset of the one or more subsequent SDT occasions that conflict in time with the one or more measurement occasions.

In some scenarios, the UE may perform SDT transmission during each of the one or more subsequent SDT occasions that conflict in time with the one or more measurement occasions.

Apparatuses and memory media are disclosed for performing any of the preceding methods.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments; and

FIG. 5 is a flow chart diagram illustrating a method for prioritizing communication functions for a UE in inactive mode, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
CG-SDT: Configured Grant SDT
DCI: Downlink Control Information
EUTRA: Evolved UMTS Terrestrial Radio Access
GSM: Global System for Mobile Communication
LTE: Long Term Evolution
MAC: Medium Access Control
NR: New Radio
PO: Paging Occasion
RAT: Radio Access Technology
RF: Radio Frequency
RRM: Radio Resource Management
RX: Reception/Receive
SDT: Small Data Transmission
TA: Timing Alignment
TX: Transmission/Transmit
UE: User Equipment
UMTS: Universal Mobile Telecommunication System

### Terms

The following is a glossary of terms that may appear in the present disclosure:
Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.
User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), virtual/augmented reality devices, etc. In general, the term “UE” or “UE device” can be broadly defined to encompass any electronic, computing, and/or telecommunications device (or combination of devices) which is easily transported by a user and capable of wireless communication.
Wireless Device—any of various types of computer systems or devices that perform wireless communications. A wireless device can be portable (or mobile) or may be stationary or fixed at a certain location. A UE is an example of a wireless device.
Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.
Base Station (BS)—The term “Base Station” has the full breadth of its ordinary meaning, and at least includes a wireless communication station installed at a fixed location and used to communicate as part of a wireless telephone system or radio system.
Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.
Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

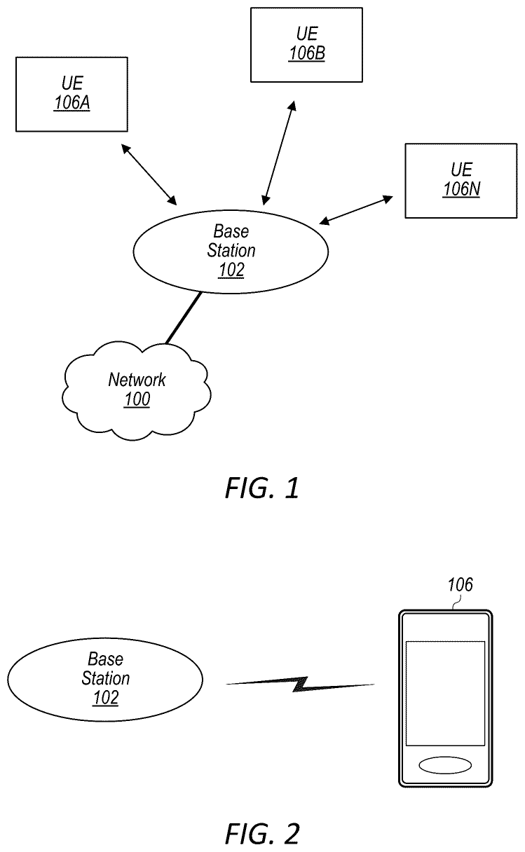

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an “eNodeB” or “eNB”. If the base station 102 is implemented in the context of 5G NR, it may alternately be referred to as a “gNodeB” or “gNB”. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1xRTT, 1xEV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to resolve conflicts between small data transmission (SDT) sessions and cell measurement, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, a virtual/augmented reality device, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1xRTT (or LTE or NR, or LTE or GSM), and separate radios for communicating using each of Wi-Fi and BLUETOOTH™. Other configurations are also possible.

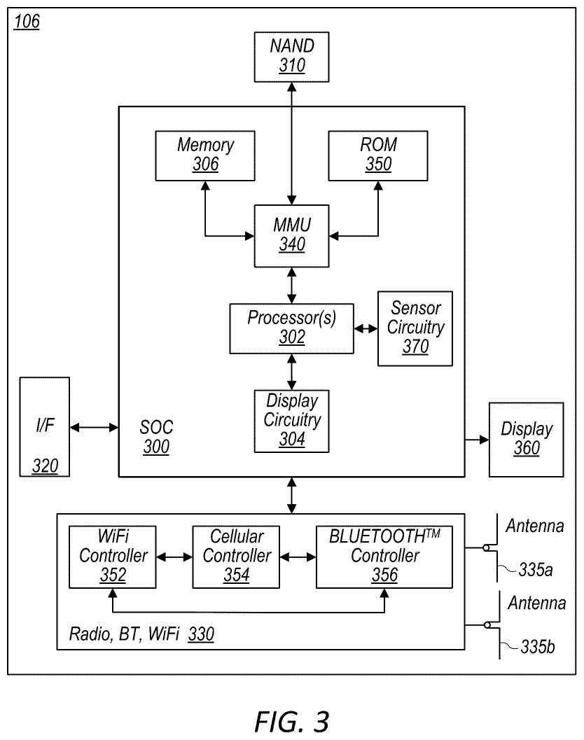

FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. In some implementations, the display 360 may include a touchscreen capable of detecting user input, e.g., as touch events. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector interface (I/F) 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted above, the UE may be configured to communicate wirelessly using multiple wireless communication standards in some embodiments.

The UE 106 may include hardware and software components for implementing methods for the UE 106 to resolve conflicts between small data transmission (SDT) sessions and cell measurement, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to resolve conflicts between small data transmission (SDT) sessions and cell measurement according to various embodiments disclosed herein. Processor(s) 302 may also implement various other applications and/or end-user applications running on UE 106

In some embodiments, radio 330 may include separate controllers dedicated to controlling communications for various respective RAT standards. For example, as shown in FIG. 3, radio 330 may include a Wi-Fi controller 352, a cellular controller (e.g., LTE, LTE-A, and/or NR controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

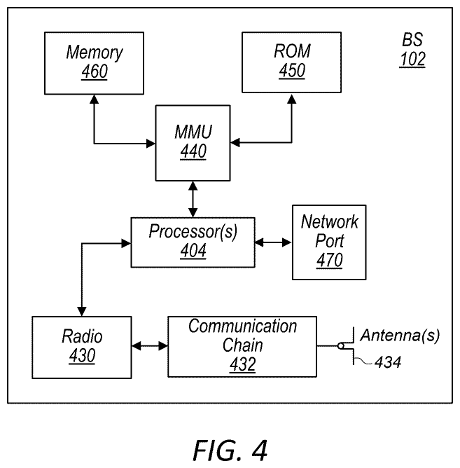

FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE device 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

### CG-SDT Collisions

In existing 3GPP standards, most uplink communications are performed while the UE is in RRC Connected mode. However, when the UE is in inactive mode, small data transmissions (SDT) may be configured to allow the UE to transmit small data sets to the base station without incurring the overhead costs of transitioning to Connected mode. This may be particularly useful, e.g., for applications involving wearable devices, IoT devices, etc., which may commonly transmit only small quantities of data at any given time, and which may be tightly constrained in terms of power budget.

One variety of SDT is connected grant SDT (CG-SDT). For CG-SDT, the network (e.g., the serving base station) may provide configuration parameters for one or more SDT transmissions. For example, the base station may include SDT configuration parameters in an RRC Release message when the UE transitions to inactive mode. The SDT configuration parameters may include, e.g., a periodicity for SDT transmit occasions. In response, the UE may transmit an SDT transmission (if the UE has data to transmit) only at the occasions defined by the specified periodicity.

The UE in inactive mode may initiate the SDT procedure by transmitting the data in parallel with an SDT request message. The SDT request message may be an RRC message. In CG-SDT, this “initial SDT transmission” may be followed by one or more “subsequent SDT transmissions” within an SDT session. In some scenarios, the initial SDT transmission may include a buffer status reporting (BSR) and/or other assistance information to request the subsequent SDT transmissions. In some implementations, the subsequent SDT transmissions may not include (and may not be transmitted in parallel with) an SDT request message or other RRC message. The initial transmission may be a protected UE behavior, in that it may be subject to various validation procedures (e.g., uplink timing alignment [TA] validation) prior to transmission. However, the subsequent SDT transmissions may not include such validations, and may therefore conflict in time with other events, such as measurement events. The UE may therefore be responsible to determine whether to transmit a subsequent SDT when the UE detects such a collision.

Collisions with different types of measurement events may be handled in different ways. For example, subsequent SDT transmissions, configured to occur according to a defined SDT periodicity following the initial SDT transmission, may potentially conflict with inter-frequency/inter-RAT neighbor cell measurement, with serving cell measurement, or with intra-frequency neighbor cell measurement. These different cases may raise different considerations when considering how to resolve the conflict. These cases are therefore addressed separately below.

### Subsequent CG-SDT Transmission Collision With Inter-Frequency/Inter-RAT Measurement

SDT transmissions are transmitted on the serving carrier. However, when a UE performs inter-frequency/inter-RAT neighbor cell measurement, the UE must typically reconfigure its RF chain to another carrier at a different frequency. Thus, while the UE is performing such measurements, it will be unable to transmit a subsequent CG-SDT transmission on the serving carrier. If the UE determines that a subsequent CG-SDT transmission conflicts in time with an inter-frequency/inter-RAT neighbor cell measurement (e.g., if the SDT occasion for the subsequent CG-SDT transmission overlaps with a window of time during which the UE's RF chain would be tuned to a different frequency to perform the scheduled measurement), then the UE may forgo either transmission of the CG-SDT or performance of the measurement. In various implementations, the UE may pursue any of various options for determining which action to forgo.

As a first option, in response to determining that a subsequent CG-SDT transmission conflicts in time with an inter-frequency/inter-RAT neighbor cell measurement, the UE may always prioritize the inter-frequency/inter-RAT neighbor cell measurement, and may forgo performing the subsequent CG-SDT transmission at the conflicting time. Prioritizing the inter-frequency/inter-RAT neighbor cell measurement may include performing the measurement or attempting to perform the measurement. Forgoing the subsequent CG-SDT transmission may include, e.g., delaying the subsequent CG-SDT transmission until a later available SDT occasion. It may be noted that delaying the CG-SDT transmission in this way may break the timing continuity of the SDT session. In response, the UE may perform an additional TA validation procedure prior to performing a CG-SDT transmission in a later SDT occasion.

As a second option, in response to determining that a subsequent CG-SDT transmission conflicts in time with an inter-frequency/inter-RAT neighbor cell measurement, the UE may always prioritize the subsequent CG-SDT transmission. Prioritizing the subsequent CG-SDT transmission may include performing or attempting to perform the transmission during a conflicting CG-SDT occasion if SDT data is available, but performing the inter-frequency/inter-RAT neighbor cell measurement during the conflicting measurement occasion if SDT data is not available. If SDT data is available, the UE may forgo performing the inter-frequency/inter-RAT neighbor cell measurement during the conflicting measurement occasion; e.g., by dropping the measurement occasion. It may be noted that dropping too many measurement occasions may impact UE timing requirements.

As a third option, the UE may consider additional conditions of the scheduling collision. For example, the UE may determine whether all subsequent CG-SDT occasions of the SDT session will conflict with inter-frequency/inter-RAT neighbor cell measurement occasions. This may be referred to as the periodic CG-SDT occasions being fully overlapped with the inter-frequency/inter-RAT neighbor cell measurement occasions. By contrast, if only a subset of the CG-SDT occasions will conflict with inter-frequency/inter-RAT neighbor cell measurement occasions, they occasions may be referred to as partially overlapped. The CG-SDT occasions may be fully overlapped with the measurement occasions, e.g., if the periodicity of the CG-SDT occasions is the same as the periodicity of the measurement occasions, or if the periodicity of the CG-SDT occasions is an integer multiple of the periodicity of the measurement occasions; e.g., if the periodicity of the measurement occasions is X ms, and the periodicity of the CG-SDT occasions is 2X ms. The CG-SDT occasions may be partially overlapped with the measurement occasions, e.g., if the periodicity of the measurement occasions is an integer multiple of the periodicity of the CG-SDT occasions; e.g., if the periodicity of the CG-SDT occasions is X ms, and the periodicity of the measurement occasions is 2X ms.

If the UE determines that the CG-SDT occasions are partially overlapped with the measurement occasions, then the UE may respond by transmitting subsequent CG-SDT transmissions during the CG-SDT occasions that do not conflict with measurement occasions, while prioritizing inter-frequency/inter-RAT neighbor cell measurement during measurement occasions that conflict with CG-SDT occasions.

If the UE determines that the CG-SDT occasions are fully overlapped with the measurement occasions, then multiple options may be available for resolving the collision. As a first example, the UE may use a scaling factor to determine which event to prioritize. For example, the UE may apply a scaling factor of ⅓. In such a scenario, the UE may prioritize a CG-SDT transmission during every third conflicting SDT occasion, while prioritizing inter-frequency/inter-RAT neighbor cell measurement during the other conflicting SDT occasions. Thus, the UE may transmit (or attempt to transmit) a subsequent CG-SDT transmission during one CG-SDT occasion out of every 3 during the SDT session. Other values of the scaling factor are also envisioned. In some implementations, the value of the scaling factor may be indicated by the network, e.g., within the SDT configuration information provided by the base station. In some implementations, the value of the scaling factor may be defined by an applicable technical standard. For example, the value of the scaling factor may be fixed or may be predetermined, based on objective considerations know to both the UE and the base station.

As another example, if the UE determines that the CG-SDT occasions are fully overlapped with the measurement occasions, the UE may use a round-robin method to perform subsequent CG-SDT transmission and inter-frequency/inter-RAT measurement. Specifically, performing a complete inter-frequency/inter-RAT measurement may include the UE measuring more than one carrier and/or beam. However, the UE may be able to measure only a single carrier/beam per measurement occasion. Thus, performing a complete inter-frequency/inter-RAT measurement may require measuring across N measurement occasions. In the round-robin method, the UE may prioritize inter-frequency/inter-RAT measurement during N consecutive measurement occasions, and may then prioritize subsequent CG-SDT transmission during one (or some other number) SDT occasions. The UE may then repeat this cycle. Thus, if the periodicity of the SDT occasions and the measurement occasions is the same, the UE may transmit one subsequent CG-SDT transmission during every N+1 CG-SDT occasions. If the periodicity of the measurement occasions is shorter than the periodicity of the SDT occasions (such that the measurement occasions occur more frequently), then the UE may transmit one subsequent CG-SDT transmission during the next SDT occasion after occurrence of N measurement occasions.

As a fourth option, the UE may consider whether an inter-frequency/inter-RAT measurement is configured as a higher priority measurement object. For example, LTE allows for some inter-frequency/inter-RAT measurement events to be indicated as higher-priority measurements (relative to other inter-frequency/inter-RAT neighbor cell measurement events), while other inter-frequency/inter-RAT measurement events may be indicated as equal-priority or lower-priority. In some implementations, in response to determining that a subsequent CG-SDT transmission conflicts in time with an inter-frequency/inter-RAT neighbor cell measurement, the UE may always prioritize an inter-frequency/inter-RAT neighbor cell measurement event that is indicated to be higher-priority. For other inter-frequency/inter-RAT neighbor cell measurement events, the UE may decide prioritization between a measurement and a subsequent CG-SDT transmission according to any of the options discussed above with regard to the second or third options.

As a fifth option, the network may indicate how to resolve a conflict between a subsequent CG-SDT transmission and an inter-frequency/inter-RAT neighbor cell measurement. For example, the base station may provide an indication, e.g., in the SDT configuration information, that a subsequent CG-SDT transmission should be prioritized over an inter-frequency/inter-RAT neighbor cell measurement. In the absence of such an indication, the UE may prioritize the inter-frequency/inter-RAT neighbor cell measurement over the subsequent CG-SDT transmission. In other implementations, the base station may indicate other prioritization configurations.

### Subsequent CG-SDT Transmission Collision With Serving Cell Measurement

With regard to a serving cell, subsequent CG-SDT transmissions may potentially conflict with paging reception and/or with a downlink measurement. When receiving a paging or measurement object on the serving cell, the UE has no need to retune its RF chain to another frequency, as when performing inter-frequency/inter-RAT neighbor cell measurement. However, the UE may nevertheless be unable to perform a subsequent CG-SDT transmission in parallel with serving cell paging or downlink measurement, e.g., because the subsequent CG-SDT transmission may occur on a different beam configuration; e.g., the uplink beam used for the subsequent CG-SDT transmission may not form a beam set with the downlink beam used for the serving cell paging or measurement. If the UE determines that a subsequent CG-SDT transmission conflicts in time with serving cell paging or downlink measurement (e.g., if the SDT occasion for the subsequent CG-SDT transmission overlaps with a window of time during which the UE is scheduled to receive paging or perform downlink measurement), then the UE may forgo either transmission of the CG-SDT or performance of the paging/measurement. In various implementations, the UE may pursue any of various options for determining which action to forgo.

It should be understood that serving cell paging is considered a high-priority operation for a UE in inactive mode. Therefore, as a first option, in response to determining that a subsequent CG-SDT transmission conflicts in time with paging, the UE may always prioritize the paging, and may forgo performing the subsequent CG-SDT transmission at the conflicting time. Prioritizing the paging may include receiving a paging message or attempting to receive the paging message. Forgoing the subsequent CG-SDT transmission may include, e.g., delaying the subsequent CG-SDT transmission until a later available SDT occasion. As previously noted, delaying the CG-SDT transmission in this way may break the timing continuity of the SDT session. In response, the UE may perform an additional TA validation procedure prior to performing a CG-SDT transmission in a later SDT occasion.

As a second option, in response to determining that a subsequent CG-SDT transmission conflicts in time with paging, the UE may determine whether the CG-SDT occasions of the SDT session are fully overlapped or partially overlapped with paging occasions (POs). If the UE determines that the CG-SDT occasions are partially overlapped with the POs, then the UE may respond by transmitting subsequent CG-SDT transmissions during the CG-SDT occasions that do not conflict with a PO, while prioritizing paging during POs that conflict with CG-SDT occasions.

If the UE determines that the CG-SDT occasions are fully overlapped with the POs, then multiple options may be available for resolving the collision. As a first example, the UE may receive paging on all POs, and may provide information to the network indicating an error for the CG-SDT occasion configuration. For example, the UE may provide such an indication to the base station on RACH, PUCCH, or PUSCH. In response to receiving the indication, the base station may reconfigure the CG-SDT occasion configuration, and may provide updated CG-SDT configuration information to the UE, e.g., via RRC signaling. Specifically, the updated configuration information may specify CG-SDT occasions that have a different periodicity than the paging, or that otherwise are not fully overlapped with the POs.

As another example, if the UE determines that the CG-SDT occasions are fully overlapped with the POs, the UE may automatically scale the PO cycle by a scaling factor M (M>1). After the PO cycle has been scaled, the subsequent CG-SDT occasions would no longer be fully overlapped with the POs. The UE may then proceed as in the partially overlapped scenario, by transmitting subsequent CG-SDT transmissions during the CG-SDT occasions that do not conflict with a PO, while prioritizing paging during POs that conflict with CG-SDT occasions. In some implementations, the value of M may be indicated by the network, e.g., within the SDT configuration information provided by the base station. In some implementations, the value of M may be defined by an applicable technical standard. For example, the value of M may be fixed or may be predetermined, based on objective considerations know to both the UE and the base station.

As a third option, the network may be constrained to configure the subsequent CG-SDT configuration information such that the SDT occasions do not conflict in time with planned POs. In such an implementation, the UE would not encounter conflicts.

In general, serving cell downlink measurement may be considered lower-priority than paging. Thus, if subsequent CG-SDT transmissions conflict in time with both paging and downlink measurement, the UE may respond based on resolving the conflict between the subsequent CG-SDT transmissions and the paging, e.g., according to one of the preceding options. However, if the UE determines that the subsequent CG-SDT transmissions conflict with serving cell downlink measurement, but not with paging, various options may be available for resolving the conflict.

As a first option, the UE may always prioritize the downlink measurement, and may forgo performing the subsequent CG-SDT transmission at the conflicting time. Prioritizing the downlink measurement may include performing the downlink measurement or attempting to perform the downlink measurement. Forgoing the subsequent CG-SDT transmission may include, e.g., delaying the subsequent CG-SDT transmission until a later available SDT occasion. As previously noted, delaying the CG-SDT transmission in this way may break the timing continuity of the SDT session. In response, the UE may perform an additional TA validation procedure prior to performing a CG-SDT transmission in a later SDT occasion.

As a second option, in response to determining that a subsequent CG-SDT transmission conflicts in time with a serving cell downlink measurement, the UE may always prioritize the subsequent CG-SDT transmission. Prioritizing the subsequent CG-SDT transmission may include performing or attempting to perform the transmission during a conflicting CG-SDT occasion if SDT data is available, but performing the downlink measurement during the conflicting measurement occasion if SDT data is not available. If SDT data is available, the UE may forgo performing the downlink measurement during the conflicting measurement occasion; e.g., by dropping the measurement occasion. It may be noted that dropping too many measurement occasions may impact UE timing requirements.

As a third option, the UE may consider additional conditions of the scheduling collision. For example, the UE may determine whether the subsequent CG-SDT occasions are partially or fully overlapped with the serving cell downlink measurement occasions.

If the UE determines that the CG-SDT occasions are partially overlapped with the measurement occasions, then the UE may respond by transmitting subsequent CG-SDT transmissions during the CG-SDT occasions that do not conflict with measurement occasions, while prioritizing serving cell downlink measurement during measurement occasions that conflict with CG-SDT occasions.

If the UE determines that the CG-SDT occasions are fully overlapped with the measurement occasions, then the UE may use a scaling factor to determine which event to prioritize, e.g., substantially as described with regard to inter-frequency/inter-RAT neighbor cell measurement. For example, the UE may apply a scaling factor of ⅓. In such a scenario, the UE may prioritize a CG-SDT transmission during every third conflicting SDT occasion, while prioritizing serving cell downlink measurement during the other conflicting SDT occasions. Thus, the UE may transmit (or attempt to transmit) a subsequent CG-SDT transmission during one CG-SDT occasion out of every 3 during the SDT session. Other values of the scaling factor are also envisioned. In some implementations, the value of the scaling factor may be indicated by the network, e.g., within the SDT configuration information provided by the base station. In some implementations, the value of the scaling factor may be defined by an applicable technical standard. For example, the value of the scaling factor may be fixed or may be predetermined, based on objective considerations know to both the UE and the base station.

As a fourth option, the network may indicate how to resolve a conflict between a subsequent CG-SDT transmission and a serving cell downlink measurement. For example, the base station may provide an indication, e.g., in the SDT configuration information, that a subsequent CG-SDT transmission should be prioritized over a serving cell downlink measurement. In the absence of such an indication, the UE may prioritize the serving cell downlink measurement over the subsequent CG-SDT transmission. In other implementations, the base station may indicate other prioritization configurations.

As a fifth option, the UE may prioritize serving cell downlink measurements that precede a PO, but may otherwise prioritize subsequent CG-SDT transmissions. This option recognizes that, to ensure the UE can successfully monitor paging, the UE may need to perform time/frequency (T/F) tracking through serving cell downlink measurement. Thus, when downlink measurement closely precedes a PO, it may be considered higher priority—e.g., prioritized as highly as paging. In some scenarios, the downlink measurement preceding the PO may be the downlink measurement occasion that is closest before the PO. In other scenarios, the downlink measurement preceding the PO may be any downlink measurement occasion within Z ms before the PO. In some implementations, the value of Z may be indicated by the network, e.g., within the SDT configuration information provided by the base station. In some implementations, the value of Z may be defined by an applicable technical standard. For example, the value of Z may be fixed or may be predetermined, based on objective considerations know to both the UE and the base station.

### Subsequent CG-SDT Transmission Collision With Intra-frequency Measurement

Conflicts between a subsequent CG-SDT transmission and an intra-frequency neighbor cell measurement are similar in many ways to conflicts between a subsequent CG-SDT transmission and a serving cell downlink measurement. For example, when performing an intra-frequency neighbor cell measurement, the UE may not need to tune away to another frequency, but the downlink beam may not form a beam set with the uplink beam used for a subsequent CG-SDT transmission on the serving cell. Thus, the UE may be unable to perform the subsequent CG-SDT transmission in parallel with the intra-frequency neighbor cell measurement.

Because the conditions are similar, the UE may respond to conflicts between a subsequent CG-SDT transmission and an intra-frequency neighbor cell measurement using any of the first through fourth options discussed above in connection with conflicts between a subsequent CG-SDT transmission and a serving cell downlink measurement. For example, in some implementations, the UE may be configured to respond to a conflict between a subsequent CG-SDT transmission and an intra-frequency neighbor cell measurement using the same option as when responding to a conflict between a subsequent CG-SDT transmission and a serving cell downlink measurement (selected from among the first four options discussed). This may simplify management of conflict resolution procedures.

In other implementations, the UE may be configured to respond to a conflict between a subsequent CG-SDT transmission and an intra-frequency neighbor cell measurement using any one of the first four options discussed, and may respond to a conflict between a subsequent CG-SDT transmission and a serving cell downlink measurement using any one of the five options discussed, without regard to which option is used to respond to a conflict between a subsequent CG-SDT transmission and an intra-frequency neighbor cell measurement.

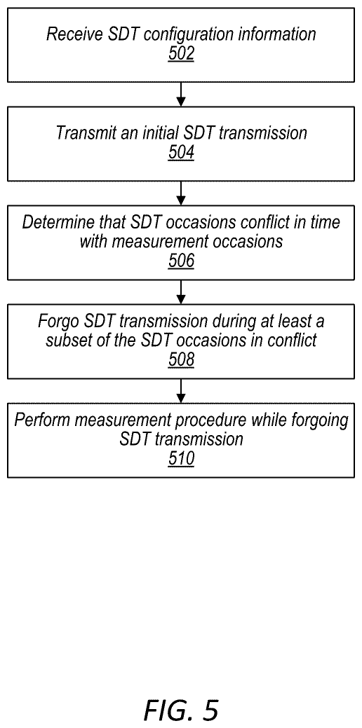

### FIG. 5—Method for Determining Prioritization

FIG. 5 is a flow chart diagram illustrating a method for prioritizing communication functions for a UE in inactive mode, according to some embodiments. The method of FIG. 5 may be performed by a UE, such as the UE 106, or by some component(s) thereof, such as by the radio 330 and/or the cellular controller 354. As shown, the method of FIG. 5 may operate as follows:

At 502, the UE 106 may receive SDT configuration information pertaining to a CG-SDT session. The SDT configuration information may include configuration parameters, such as periodicity of SDT transmissions, including subsequent transmissions. In some scenarios, a serving base station, such as the base station 102, may provide the SDT configuration information, e.g., within an RRC Release message when the UE 106 transitions to inactive mode, or in other messaging.

At 504, the UE 106 may transmit to the serving base station an initial SDT transmission, e.g., according to the SDT configuration information. In some scenarios, the initial SDT transmission may include (or may be accompanied by) information regarding additional data to be transmitted in subsequent SDT transmissions.

At 506, the UE 106 may determine that one or more subsequent SDT occasions of a plurality of periodic subsequent SDT occasions of an SDT session conflict in time with one or more measurement occasions of a plurality of measurement occasions scheduled during the SDT session. The subsequent SDT occasions may be determined based on the SDT configuration information received at 502, and may represent times at which the UE 106 would transmit subsequent SDT transmissions, in the absence of any conflict. The plurality of measurement occasions scheduled during the SDT session may represent times at which the UE 106 is scheduled to perform measurement procedures. The measurement occasions scheduled during the SDT session may include measurement occasions from one or more sets of periodic measurement occasions. For example, the sets of periodic measurement occasions may include a set of periodic inter-frequency neighbor cell measurement occasions, a set of periodic inter-RAT neighbor cell measurement occasions, a set of periodic intra-frequency neighbor cell measurement occasions, a set of periodic serving cell downlink measurement occasions, and/or a set of periodic serving cell paging occasions.

At 508, the UE 106 may, in response to the determining, forgo SDT transmission during at least a subset of the one or more subsequent SDT occasions that conflict in time with the one or more measurement occasions.

At 510, the UE 106 may perform a measurement procedure on at least a subset of the measurement occasions during which the UE forgoes SDT transmission. For example, in some scenarios, the UE 106 may perform a measurement procedure on each of the measurement occasions during which the UE forgoes SDT transmission.

As discussed above, the UE may pursue any of a number of options in determining which SDT occasions to utilize or forgo at 508, and which measurement occasions to utilize or forgo at 510. In some implementations, various options may be available to the UE based on the circumstances. In some implementations, the option to be used by the UE in response to a given type of conflict may be predetermined, e.g., by an applicable technical standard. Some options may be available in response to one type of conflict (e.g., a conflict between a subsequent SDT transmission and an inter-frequency neighbor cell measurement), but may not be available in response to another type of conflict (e.g., a conflict between a subsequent SDT transmission and a serving cell paging occasion). Various options and their applicability to different types of conflicts are discussed above.

In some implementations, forgoing SDT transmission during at least the subset of the one or more subsequent SDT occasions at 508 may include forgoing SDT transmission during each subsequent SDT occasion that conflicts in time with the one or more measurement occasions, and performing SDT transmission during each subsequent SDT occasion that does not conflict in time with the one or more measurement occasions. In some scenarios, such implementations may further include performing a measurement procedure on each of the measurement occasions during which the UE forgoes SDT transmission, and forgoing a measurement procedure on each of the measurement occasions during which the UE performs SDT transmission.

In some implementations, forgoing SDT transmission during at least the subset of the one or more subsequent SDT occasions at 508 may include delaying SDT transmission until a later SDT occasion that does not conflict in time with a measurement occasion. In such cases, the UE 106 may also perform a TA validation procedure after delaying the SDT transmission, but before the later SDT occasion.

In some implementations, forgoing SDT transmission during at least the subset of the one or more subsequent SDT occasions at 508 may include determining whether all of the subsequent SDT occasions of the SDT session conflict in time with measurement occasions of the plurality of measurement occasions scheduled during the SDT session. For example, the UE may determine that all of the subsequent SDT occasions of the SDT session conflict in time with measurement occasions of the plurality of measurement occasions scheduled during the SDT session based at least in part on a determination that the plurality of periodic subsequent SDT occasions has a periodicity that is the same as a periodicity of at least a subset of the plurality of measurement occasions that is included in a set of periodic measurement occasions (e.g., the same as a periodicity of one type of measurement occasion, such as serving cell downlink measurement occasions). Similarly, the UE may determine that less than all of the subsequent SDT occasions of the SDT session conflict in time with measurement occasions of the plurality of measurement occasions scheduled during the SDT session based at least in part on a determination that the plurality of periodic subsequent SDT occasions has a periodicity that is longer than a periodicity of at least a subset of the plurality of measurement occasions that is included in a set of periodic measurement occasions. However, it should be understood that the scheduling of all types of measurement occasions should be considered when determining whether all of the subsequent SDT occasions of the SDT session conflict in time with measurement occasions of the plurality of measurement occasions scheduled during the SDT session.

As an example, in response to determining that all of the subsequent SDT occasions of the SDT session conflict in time with measurement occasions of the plurality of measurement occasions scheduled during the SDT session, the UE 106 may, at 508, forgo SDT transmission on a fraction (or ratio, percentage, etc.) of the subsequent SDT occasions specified by a scaling factor. E.g., a scaling factor of ⅓ may indicate that the UE 106 may perform SDT transmission during one out of every three SDT occasions, and may forgo SDT transmission on the remaining occasions. In some scenarios, the UE 106 may receive from the serving base station a value of the scaling factor. In some scenarios, the value of the scaling factor may be predetermined, e.g., by an applicable technical standard.

As another example, in response to determining that all of the subsequent SDT occasions of the SDT session conflict in time with measurement occasions of the plurality of measurement occasions scheduled during the SDT session, the UE 106 may forgo SDT transmission until N measurement occasions have occurred. Here, N may represent a number of carriers that the UE is scheduled to measure in connection with an inter-frequency neighbor cell measurement.

As yet another example, in response to determining that all of the subsequent SDT occasions of the SDT session conflict in time with measurement occasions of the plurality of measurement occasions scheduled during the SDT session, the UE 106 may forgo SDT transmission during each of the one or more subsequent SDT occasions of the SDT session. In such scenarios, the UE may also provide to the serving base station an indication that an SDT occasion configuration error has occurred.

As yet another example, in response to determining that all of the subsequent SDT occasions of the SDT session conflict in time with paging occasions of the plurality of measurement occasions scheduled during the SDT session, the UE 106 may scale a cycle length of the paging occasions. In some such scenarios, the UE 106 may receive from the serving base station an indication of a factor by which the cycle length of the paging occasions is to be increased. In other such scenarios, the factor by which the cycle length is to be increased may be predetermined, e.g., by an applicable technical standard.

In a somewhat different example, in response to determining that less than all of the subsequent SDT occasions of the SDT session conflict in time with measurement occasions of the plurality of measurement occasions scheduled during the SDT session, the UE may perform a subsequent SDT transmission during a subsequent SDT occasion of the SDT session that does not conflict in time with a measurement occasion of the plurality of measurement occasions.

In some implementations, forgoing SDT transmission during at least the subset of the one or more subsequent SDT occasions at 508 may include determining that a measurement object scheduled for measurement during a particular measurement occasion of the plurality of measurement occasions scheduled during the SDT session is a higher-priority measurement object, and forgoing SDT transmission during the particular measurement occasion.

It should be understood that the preceding method is one example, and numerous variations are also envisioned. In some scenarios, one or more steps may be omitted or reordered, and/or additional steps may be added. For example, in some scenarios, the method may exclude 502-504 for conciseness. As another example, in some scenarios, 508 may be modified to indicate that the UE 106 may perform subsequent SDT transmission during at least a subset of the one or more subsequent SDT occasions that conflict in time with the one or more measurement occasions. Other variations are also envisioned.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method comprising:
by a user equipment (UE):
determining that one or more subsequent small data transmission (SDT) occasions of a plurality of periodic subsequent SDT occasions of an SDT session conflict in time with one or more measurement occasions of a plurality of measurement occasions scheduled during the SDT session; and
in response to the determining, forgoing SDT transmission during at least a subset of the one or more subsequent SDT occasions that conflict in time with the one or more measurement occasions.

2. The method of claim 1, further comprising:
by the UE:
performing a measurement procedure on at least a subset of the measurement occasions during which the UE forgoes SDT transmission.

3. The method of claim 1, wherein forgoing SDT transmission during at least the subset of the one or more subsequent SDT occasions comprises delaying SDT transmission until a later SDT occasion that does not conflict in time with a measurement occasion.

4. The method of claim 3, further comprising:
by the UE:
performing a timing alignment (TA) validation procedure after delaying the SDT transmission, but before the later SDT occasion.

5. The method of claim 1, further comprising:
by the UE:
in response to determining that all of the subsequent SDT occasions of the SDT session conflict in time with measurement occasions of the plurality of measurement occasions scheduled during the SDT session, forgoing SDT transmission on a fraction of the subsequent SDT occasions specified by a scaling factor.

6. The method of claim 5, further comprising:
by the UE:
receiving from a base station an indication of a value of the scaling factor.

7. The method of claim 5, wherein determining that all of the subsequent SDT occasions of the SDT session conflict in time with measurement occasions of the plurality of measurement occasions scheduled during the SDT session comprises determining that the plurality of periodic subsequent SDT occasions has a periodicity that is the same as a periodicity of at least a subset of the plurality of measurement occasions that is included in a set of periodic measurement occasions.

8. The method of claim 1, further comprising:
by the UE:
in response to determining that all of the subsequent SDT occasions of the SDT session conflict in time with measurement occasions of the plurality of measurement occasions scheduled during the SDT session, forgoing SDT transmission until N measurement occasions have occurred, wherein N represents a number of carriers that the UE is scheduled to measure in connection with an inter-frequency neighbor cell measurement.

9. The method of claim 1, further comprising:
by the UE:
in response to determining that all of the subsequent SDT occasions of the SDT session conflict in time with measurement occasions of the plurality of measurement occasions scheduled during the SDT session, forgoing SDT transmission during each of the one or more subsequent SDT occasions of the SDT session.

10. The method of claim 1, further comprising:
by the UE:
in response to determining that all of the subsequent SDT occasions of the SDT session conflict in time with measurement occasions of the plurality of measurement occasions scheduled during the SDT session, providing to a base station an indication that an SDT occasion configuration error has occurred.

11. The method of claim 1, further comprising:
by the UE:
in response to determining that all of the subsequent SDT occasions of the SDT session conflict in time with paging occasions of the plurality of measurement occasions scheduled during the SDT session, scaling a cycle length of the paging occasions.

12. The method of claim 1, further comprising:
by the UE:
in response to determining that a first subsequent SDT occasion of the one or more subsequent SDT occasions conflicts in time with a serving cell downlink measurement occasion of the measurement occasions scheduled during the SDT session, the serving cell downlink measurement occasion preceding a paging occasion of the measurement occasions scheduled during the SDT, forgoing SDT transmission during the first subsequent SDT occasion.

13. The method of claim 1, further comprising:
by the UE:
in response to determining that less than all of the subsequent SDT occasions of the SDT session conflict in time with measurement occasions of the plurality of measurement occasions scheduled during the SDT session, performing a subsequent SDT transmission during a subsequent SDT occasion of the SDT session that does not conflict in time with a measurement occasion of the plurality of measurement occasions.

14. The method of claim 1, further comprising:
by the UE:
determining that a measurement object scheduled for measurement during a particular measurement occasion of the plurality of measurement occasions scheduled during the SDT session is a higher-priority measurement object; and
forgoing SDT transmission during the particular measurement occasion.

15. The method of claim 1, wherein the plurality of measurement occasions scheduled during the SDT session includes measurement occasions from one or more sets of periodic measurement occasions.

16. The method of claim 15, wherein the one or more sets of periodic measurement occasions include one or more of:
a set of periodic inter-frequency neighbor cell measurement occasions;
a set of periodic inter-RAT neighbor cell measurement occasions;
a set of periodic intra-frequency neighbor cell measurement occasions;
a set of periodic serving cell downlink measurement occasions; or a set of periodic serving cell paging occasions.

17. The method of claim 1, further comprising:
by the UE:
forgoing SDT transmission during each subsequent SDT occasion that conflicts in time with the one or more measurement occasions; and
performing SDT transmission during each subsequent SDT occasion that does not conflict in time with the one or more measurement occasions.

18. A method comprising:
by a user equipment (UE):
determining that one or more subsequent SDT occasions of a plurality of periodic subsequent SDT occasions of a SDT session conflict in time with one or more measurement occasions of a plurality of measurement occasions scheduled during the SDT session; and
in response to the determining, performing subsequent SDT transmission during at least a subset of the one or more subsequent SDT occasions that conflict in time with the one or more measurement occasions.

19. The method of claim 18, further comprising:
by the UE:
performing SDT transmission during each of the one or more subsequent SDT occasions that conflict in time with the one or more measurement occasions.

20. An apparatus comprising:
memory, storing software instructions; and
at least one processor configured to execute the software instructions to cause a user equipment (UE) to perform the method of any of claims 1-19.
